(19) United States
(12) Patent Application Publication
(10) Pub. No.: US 2010/0161380 A1
(43) Pub. Date: Jun. 24, 2010

(54) RATING-BASED INTERESTS IN COMPUTING ENVIRONMENTS AND SYSTEMS

(75) Inventors: Yu SONG, Pleasanton, CA (US); Sangoh JEONG, Palo Alto, CA (US); Doreen CHENG, San Jose, CA (US); Swaroop KALASAPUR, Santa Clara, CA (US)

Correspondence Address: Beyer Law Group LLP, P.O. BOX 1687, Cupertino, CA, 95015-1687, US

(73) Assignee: SAMSUNG ELECTRONICS CO., LTD., Gyeonggi-Do (KR)

(21) Appl. No.: 12/343,392

(22) Filed: Dec. 23, 2008

(51) Int. Cl. G06Q 30/00; G06N 5/02; G06Q 10/00

(52) U.S. Cl. 705/10; 706/52; 705/14.58

(57) ABSTRACT

An interest in an object of interest in a given situation can be determined by determining multiple sets of probability values for specific interest levels. Each set of probability values includes a probability that a specific interest level occurs in a situation represented by a plurality of context variables each having a plurality of possible context values. Input context values are then obtained. The relevance of each one of the sets of probability values to the input context values can be determined in order to determine a projected interest level.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information used by a computing system is stored in a computer readable memory using a digital or binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known as an Operating System (OS) which provides programmers with an interface used to access these resources and services.

Today, numerous types of computing devices are available. These computing devices widely range with respect to size, cost, amount of storage and processing power, from the expensive and powerful servers, relatively cheaper Personal Computers (PC's) and laptops, to more inexpensive microprocessors or computer chips provided in storage devices, automobiles, and household electronic appliances.

A popular task for many computing devices is to link people with relevant information. Different computing devices perform such linking in a variety of ways, depending on the needs of a particular application. Many people, for example, are accustomed to typing in keywords into an Internet search engine to find desirable information. Visitors to an e-commerce site are often greeted with ads and recommendations tailored to their preferences. Particular computing devices derive such recommendations from a comparison between the visitor's past purchasing decisions and the purchasing decisions of other users.

Generation of recommendations in this manner can involve the processing of large amounts of user data. As will be appreciated by those skilled in the art, various techniques can be used to optimize such processing. Some computing devices use fixed, predetermined rules that prioritize one type of user data over another in making a recommendation. Other computing devices, for example, pose direct questions to a user to determine what the user desires at a later time.

Some applications use clustering techniques for recommendation. For example, one clustering technique involves dividing a pool of users into K clusters of users. A computing device calculates the center of each of the clusters. The computing device further determines the closest cluster to a new user and bases a recommendation for the new user on that cluster.

These approaches, while effective in some situation can have weaknesses. Direct questioning is often disliked by users and consumes time and overhead. Rules typically require updating and may be based on faulty assumptions. A computing device that clusters data typically predetermines a number of “K” clusters. If the device selects an incorrect value for “K”, the resulting recommendation may be flawed. Additionally, if the computing device receives additional data regarding other users, K may have to be reset and the clusters may have to be reconstituted.

Another weakness of current approaches is that they do not seem to generate recommendations based on multiple contexts, such as the time of day and location.

Accordingly, techniques that can help computing devices make better recommendations for one or more users would be useful.

### SUMMARY OF THE INVENTION

Broadly speaking, the invention relates to computing systems. More particularly, the invention pertains to techniques for determining one or more interests of a user, given multiple contexts, conditions and/or circumstances.

In accordance with one aspect of the invention, an interest in an object of interest can be determined in a given situation. A situation may be represented by multiple context variables (e.g., time, place etc.) Each context variable has multiple possible context values (e.g., the context variable “time” may have context values “morning” and “evening,” etc.) In one embodiment, sets of probability values are determined for specific interest levels. Each set of probability values includes a probability that a specific interest level occurs in a situation represented by one or more context variables (e.g., “there is a 50% chance that a high level of interest in music occurs when the user is at home in the evening.”) Input context values are then obtained. These input context values (e.g., “morning at home”) effectively represent an input situation. The relevance of each one of the sets of probability values to the input context values is determined. Based at least partly on this determination, a projected interest value is determined. This projected interest value predicts an interest value for the input situation.

Various embodiments of the invention use a wide variety of context variables, context values, interest objects and/or interest levels. For example, the context variables and values may pertain to environmental variables (e.g., proximity to other devices or human beings, temperature, GPS signals, motion, acceleration etc.), internal variables (e.g., active applications on a computer, time, mode of operation etc.) and/or other factors. The incorporation of multiple context variables helps improve the accuracy and relevance of the resulting interest value determination.

Various embodiments may entail different types of encoding and predicting operations, depending on the needs of a particular application. For example, sets of probability values and context values are encoded as binary, multi-dimensional vectors. As another example, the prediction of a projected interest level may use a weighted sum. The weighted sum may take many forms. The weighted sum calculation may be based at least partly on the calculating of a distance between a vector associated with a set of probability values and a vector representing the input context values. The calculating of a distance may use a cosine distance formula, a Euclidean distance formula or some other type of formula and/or algorithm.

The invention can be implemented in numerous ways, including, for example, a method, an apparatus, a computer readable medium, and a computing system (e.g., one or more computing devices). Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 depicts a computing system in accordance with various embodiments of the invention.

FIG. 2 depicts a method for predicting a specific level of interest in an interest object in a situation in accordance with various embodiments of the invention.

FIG. 3A illustrates a set of data associations in accordance with various embodiments of the invention.

FIG. 3B illustrates an exemplary set of data associations in accordance with various embodiments of the invention.

FIG. 4A depicts multiple sets of probability values in accordance with various embodiments of the invention.

FIG. 4B depicts an exemplary set of probability values in accordance with various embodiments of the invention.

FIG. 5 depicts a block diagram of an interest level predictor, interest levels and their associated weights in accordance with various embodiments of the invention.

### DETAILED DESCRIPTION OF THE INVENTION

The invention pertains to techniques for determining one or more interests of a user, given multiple contexts, conditions and/or circumstances.

In accordance with one aspect of the invention, an interest in an object of interest can be determined in a given situation. A situation may be represented by multiple context variables (e.g., time, place etc.). Each context variable has multiple possible context values (e.g., the context variable “time” may have context values “morning” and “evening,” etc.). In one embodiment, sets of probability values are determined for specific interest levels. Each set of probability values includes a probability that a specific interest level occurs in a situation represented by one or more context variables (e.g., “there is a 50% chance that a high level of interest in music occurs when the user is at home in the evening”). Input context values are then obtained. These input context values (e.g., “morning at home”) effectively represent an input situation. The relevance of each one of the sets of probability values to the input context values is determined. Based at least partly on this determination, a projected interest value is determined. This projected interest value predicts an interest value for the input situation.

Various embodiments of the invention use a wide variety of context variables, context values, interest objects and/or interest levels. For example, the context variables and values may pertain to environmental variables (e.g., proximity to other devices or human beings, temperature, GPS signals, motion, acceleration etc.), internal variables (e.g., active applications on a computer, time, mode of operation etc.) and/or other factors. The incorporation of multiple context variables helps improve the accuracy and relevance of the resulting interest value determination.

Various embodiments may entail different types of encoding and predicting operations, depending on the needs of a particular application. For example, sets of probability values and context values are encoded as binary, multi-dimensional vectors. As another example, the prediction of a projected interest level may use a weighted sum. The weighted sum may take many forms. The weighted sum calculation may be based at least partly on the calculating of a distance between a vector associated with a set of probability values and a vector representing the input context values. The calculating of a distance may use a cosine distance formula, a Euclidean distance formula or some other type of formula and/or algorithm.

As noted earlier, various techniques exist for making recommendations on behalf of a user. These techniques are effective in certain circumstances but have weaknesses as well. Some of these techniques, for example, involve directly questioning users about their interests, utilizing fixed, predetermined rules that value one type of user data over another, or arranging data into a predetermined number of clusters.

It will be appreciated that the invention does not require such features and yet can allow predicting interest in an interest object based at least partly on multiple context variables. In certain embodiments, sets of probability values are determined that reflect the likelihood that certain interest levels arise in specific contexts. The interest level in an interest object is predicted using these probability values. An example of a particular embodiment may involve a device that automatically recommends a spreadsheet application to a user, based on the prediction that the user is highly likely to have a strong interest in the application when the time is 3 o'clock and the user is at home rather than at work. The techniques of the invention can extend to a wide variety of computer systems, devices, hardware arrangements, environments and applications.

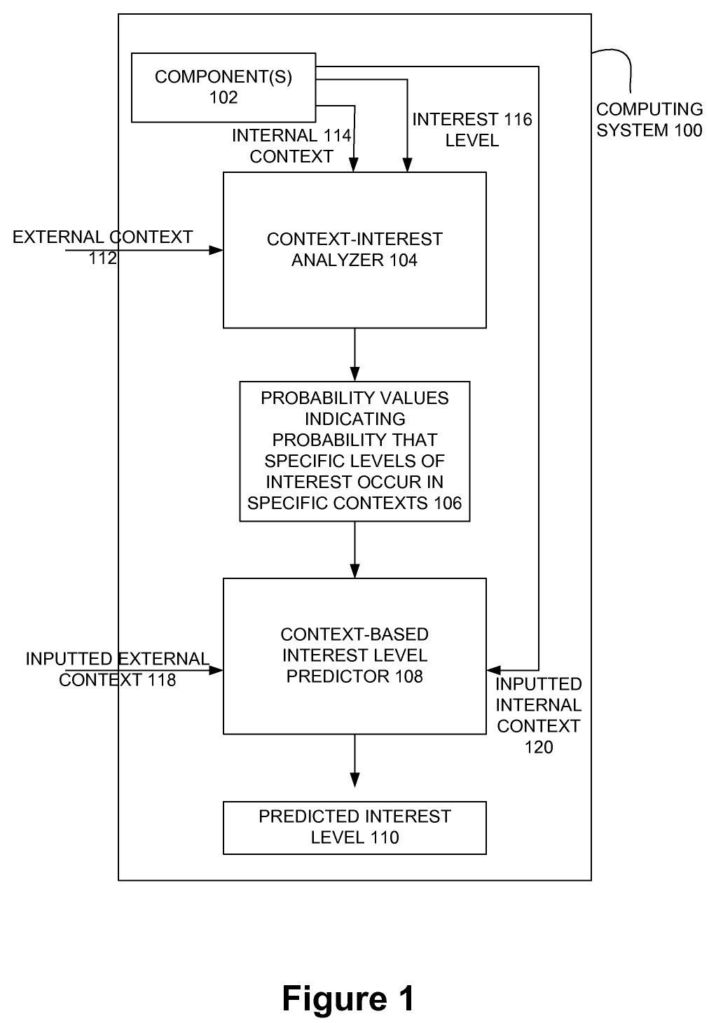

One embodiment of the invention is presented in FIG. 1. FIG. 1 illustrates computing system 100, which includes one or more components 102, context-interest analyzer 104 and context-based interest level predictor 108. In the illustrated embodiment, components 102 run applications, observe processes in the system and/or store logs of past activity etc. Computing system 100 has one or more processors (not shown) and may be configured for, adapted, and/or operable to perform operations related to determining an interest in an object of interest in a situation. For example, computing system 100 may be a mobile device, a server and one or more clients and/or multiple computer devices.

Context-interest analyzer 104 is configured to determine probabilities that a specific interest level will arise in a variety of contexts. In the illustrated embodiment, the probabilities are based on data accumulated from various internal and external sources. Context-interest analyzer 104 receives data relating to internal contexts 114 from components 102 and external contexts 112 from the outside environment. The types of contexts examined by the context-interest analyzer 104 can vary widely, depending on the needs of a particular application. Examples of internal contexts include the number and type of applications that are currently running, modes of operation, logs of past user behavior and/or timing information. Examples of external contexts may include data relating to location, speed, motion, proximity to a device, GPS signals and/or temperature. Context-interest analyzer 104 may take into account other factors and contexts as well.

Based on the above data, context-interest analyzer 104 produces probability data 106. Probability data 106 relates to probability values indicating the probability that specific levels of interest occur in specific contexts. For example, one iteration of probability data 106 may indicate that a high level of interest in gaming applications is less likely to occur in the afternoon but is more likely to occur in the morning and evening and is more likely to occur at home but less likely to occur at work. Probability data 106 may be arranged and configured in a variety of different ways, depending on the needs of a particular application.

Probability data 106 is then received by context-based interest level predictor 108. Context-based interest level predictor 108 also receives additional input external contexts 118 and input internal contexts 120. Context-based interest level predictor 108 uses this data to generate predicted interest level 110. In the illustrated embodiment, predicted interest level 110 is an estimation of the interest level in an interest object that would occur in a situation represented by input external contexts 118 and input internal contexts 120. To use a very simple example, context-based interest level predictor 108 may receive input relating to a location-based external context (e.g., “workplace”) and a time-based internal context (e.g., “the afternoon”). Based on probability data 106 and these inputted context values, the context-based interest level predictor 108 in this example may predict that the interest level in, say, a gaming application would be “high” as opposed to “medium” or “low.” Of course, the characteristics and operations of the context-based interest level predictor 108 may vary widely, depending on the needs of a particular application.

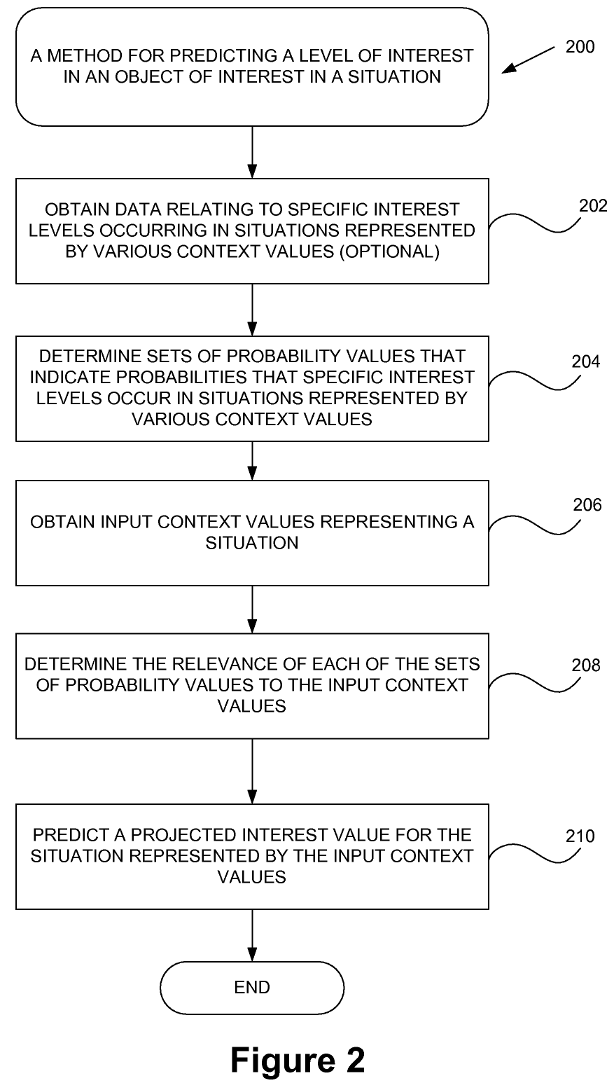

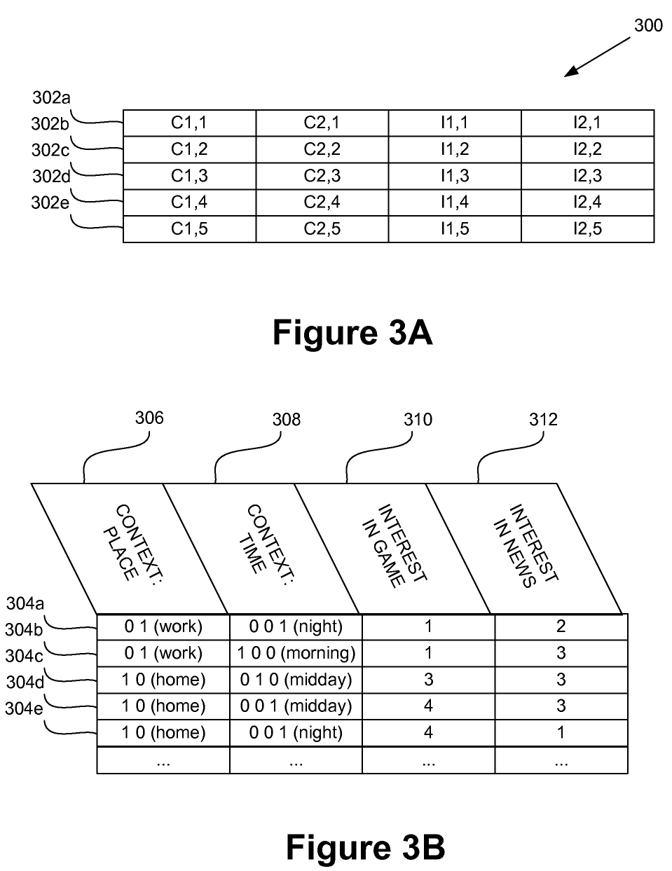

One embodiment of the invention, illustrated in FIG. 2, pertains to a method 200 that, given a certain situation, predicts an interest level in an interest object. The operations in FIG. 2 will be elaborated upon in further detail with reference to FIGS. 3A to 5. However, those skilled in the art will readily appreciate that the detailed description given herein with respect to these figures is for explanatory purposes as the invention extends beyond these limited embodiments. The method begins with optional step 202 of FIG. 2, which involves obtaining data relating to specific interest levels occurring in situations characterized by various context values.

Such data may take a variety of different forms. For example, certain types of data involve a linking between a specific level of interest in an interest object (e.g., a high level of interest in pop music) and two or more context values (e.g., being at home, in the evening). Other types of data may be less or more specific and/or integrate other factors. The data may be drawn from the actions of one or more users, the tracking or observation of patterns of behavior, and/or be estimates. The data can be formatted and stored in a variety of ways as well. For example, the data can take the form of multiple data associations, in which context variables, which represent one or more situations, are associated with specific interest levels.

FIG. 3A illustrates an example of one type of data association. FIG. 3A includes data association set 300, which includes data associations 302a-e, which are structured as rows in the illustrated embodiment. Each data association has context variables C1 and C2 and interest levels I1 and I2. Each context variable C1 and C2 can be filled with one or more possible context values, which in some embodiments are limited to a specific range of discrete context values. Alternatively, context values may be drawn from an unlimited number of values. Interest values can be similarly broad or constrained. In this embodiment, the context variables C1 and C2 help characterize a situation and the interest levels I1 and I2 help measure a degree of interest in two different interest objects.

A simple, more detailed example of the data association in FIG. 3A is provided in FIG. 3B. In the illustrated embodiment, five data associations 304a-e are presented in rows. The context variables 306 and 308 relate to place and time. The interest objects include an interest 310 in a game application and an interest 312 in a news application. Each data association 304a-e has context values for the context variables and interest values for the interest objects. For example, data association 304a has context variable “place” with the context value “work”, context variable “time” with the context value “night” and an interest level of 1 in a gaming application and an interest level of 2 in a news application. This data association could be taken to mean, for example, that at one point in time, a user evidenced a low level of interest in a gaming application but a slightly higher level of interest in a news application at work during the night. Other interpretations and relationships between the various values and variables are also possible. Other data associations may have similar or different values.

It should be appreciated that the data associations, variables and/or values may be configured in a variety of ways, depending on the needs of a particular application. In certain embodiments, context values and interest levels may be predefined and/or limited to a discrete number of values. For example, in the highly simplified example of FIG. 3B, the context values for the context variables “place” and “time” are encoded as multi-dimensional, binary vectors (i.e. vectors that encode data in the form of multiple 0's and 1's or other equivalent values). Context variable “place” has two possible context values, “home” and “work,” which are encoded as “1 0” and “0 1” respectively. Context variable time has three possible context values, “morning,” “midday” and “night,” which are encoded as “1 0 0”, “0 1 0” and “0 0 1” respectively. In some embodiments, this binary, vector-based encoding technique, which may be applied to data associations, context values, interest values and/or other types of data, helps simplify the prediction process, as will be discussed later in the application. Other types of encoding are also possible.

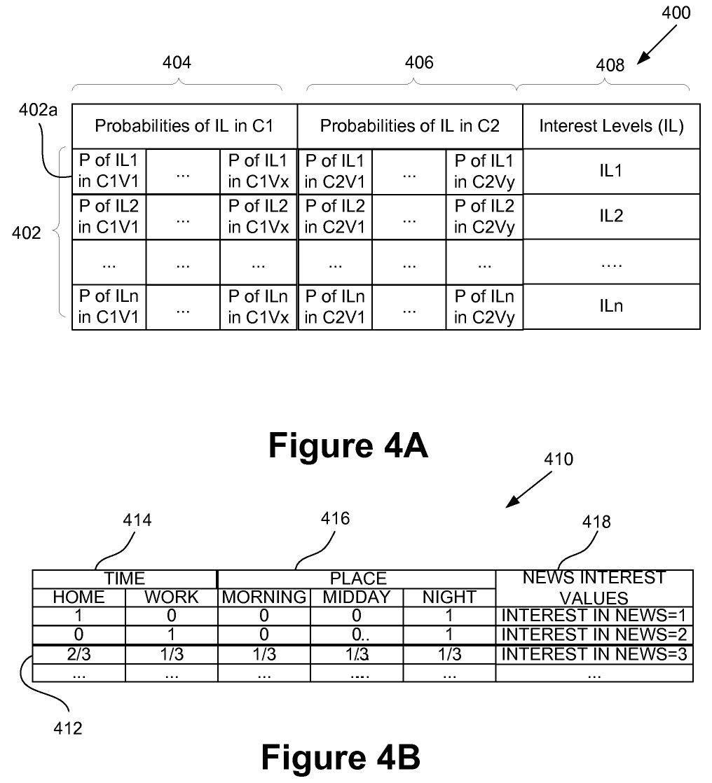

In step 204 of FIG. 2, sets of probability values are determined. In particular embodiments, these sets of probability values indicate, at least in part, the probabilities that specific interest levels occur in certain types of situations. The situations in turn can be represented by various context values. FIG. 4A helps to illustrate one simple example of this concept. (Of course, numerous other variations are also possible.) FIG. 4A displays multiple sets of probability values 402, which are arranged in rows. Each set of probability values has fields relating to context variable C1 404, context variable C2 406 and interest object 408. More specifically, each set of probability values 402 is assigned to a different interest level (IL) of n interest levels. Furthermore, each set of probability values 402 indicates the probabilities that its assigned interest level will arise in various situations characterized by multiple context values. For example, in the illustrated embodiment, context variable 404 has x possible context values C1V1 to C1Vx. Context variable 406 has y possible context values C2V1 to C2Vy. Probability set 402a indicates the probabilities that interest level IL1 arises in association with different context values C1V1 to C1Vx and C2V1 to C2Vy.

The arrangement and configuration of sets of probability values may vary, depending on the needs of a particular application. For example, sets of probability values 402 may contain fewer or more context variables, context values, interest variables, interest objects and/or other factors. In particular embodiments, the number of sets of probability values is the same as the total number of possible interest levels (e.g., if the interest object has x possible levels and/or options, in some embodiments of the invention the number of sets of probability values is exactly x). The number of probability values in a set may or may not be equal to the number of possible context values. In particular sets of probability values, some interest levels or context values may be missing. In some embodiments, each set of probability values is associated with only one interest level for one interest object. Particular embodiments involve sets of probability values in which the number and/or type of context variables, possible context values, interest objects and/or possible interest levels are predefined and/or limited to a discrete number. To use a simple example, an interest in music could be expressed using 1 of only 6 possible interest levels. The sets of probability values can be created, processed and/or stored in various kinds of hardware, software and/or both. Some embodiments involve storing sets of probability values in a computer readable medium, such as a hard drive or flash memory.

FIG. 4B is a simple example that is based on the particular embodiment illustrated in FIG. 3B. FIG. 4B shows a plurality of sets of probability values 410, although only three sets are visible. Sets of probability values 410 includes context variable “time” 414, context variable “place” 416 and interest 418, which represents an interest in interest object “news.” Context variable “time” 414 has two possible context values, “home” and “work.” Context variable “place” 416 has three possible context values, “morning”, “midday” and “night.” Interest 418 has possible interest levels ranging from 0 to 4.

Probability set 412 is associated with an interest level=3 in the interest object “news.” Additionally, probability set 412 indicates that such an interest level takes place ⅔ of the time in association with “time” context value “home” and ⅓ of the time in association with “time” context value “work.” Moreover, probability set 412 further indicates that an interest level=3 is equally likely to occur in each one of “place” context values “morning,” “midday” and “night.” In this manner, probability set 412 indicates the probabilities that an interest level=3 in news will arise in various times and locations.

Probability sets can be determined in a wide variety of ways, depending on the needs of a particular application. In the particular embodiment illustrated in FIG. 4B, the values were derived from the data associations 304a-e in FIG. 3B. Set of probability values 412 will be used as an example. Set 412 represents the probabilities that an interest level=3 in news would arise under various context values, such as “home,” “work,” “morning” etc. To calculate set 412, all data associations of FIG. 3B with an interest in news=3 were examined, i.e. data associations 304b-d of FIG. 3B. The structuring of the context values as binary vectors helps simplify the calculation of probabilities. For example, the context value “work” was translated into a 2-bit vector that had a 1 only in the second position. To calculate the probability that an interest level=3 would arise at work, the second bit is simply summed over data associations 304b-d and then divided by the number of data associations sharing that interest level (e.g., 1+0+0=⅓). A similar method was used to calculate the remaining probabilities in set 412 of FIG. 4B. The above averaging operation presents only one very simple way of determining a set of probability values that associate a specific interest level with multiple context variables and values. Various other techniques may also be used.

In step 206 of FIG. 2, input context values are received. These input context values can take on various forms and be derived from a variety of sources. In some embodiments, the range of possible input context values are similar to or exactly the same as the possible context values for the content variables. The input context values may characterize a situation from the past, present, future and/or be selected arbitrarily. To use a simple example, the input context values in one embodiment may involve recognizing that a user is currently at “work” in the “morning” and is “running a spreadsheet application.”

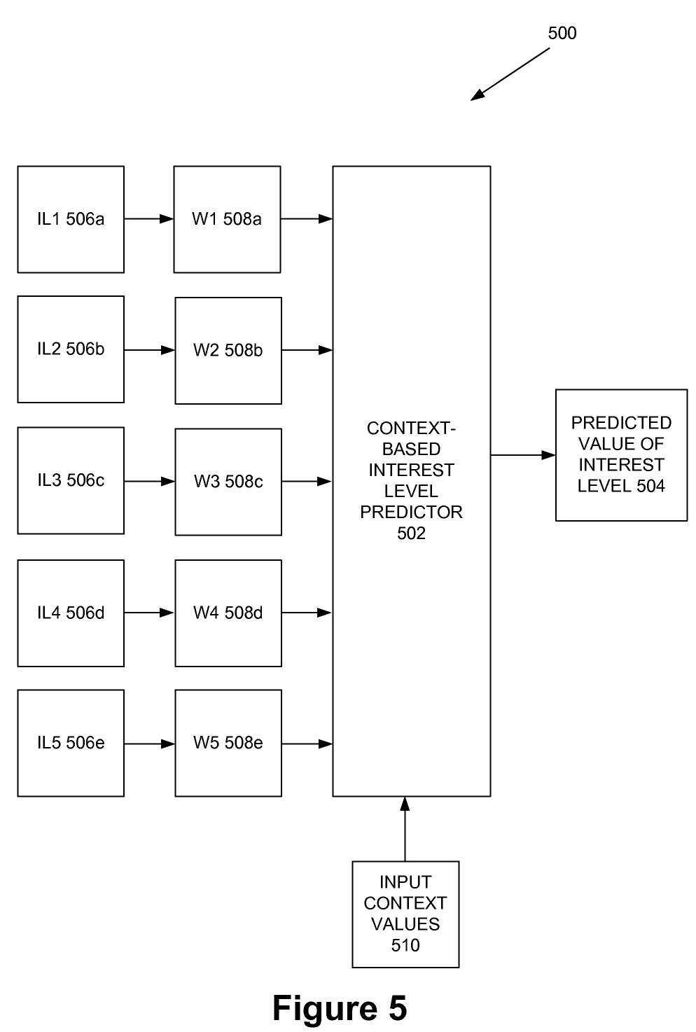

In step 208 of FIG. 2, the relevance of each of the probability values to the input context values is determined. In step 210, a projected interest value for the situation represented by the input context values is predicted based at least partly on the results of step 208. The way in which these steps are performed varies greatly, depending on the needs of a particular application. One embodiment of such operations is presented in simplified form in FIG. 5.

FIG. 5 presents context-based interest level predictor 502, which outputs predicted value of interest level 504. Context-based interest level predictor 502 has multiple inputs, including input context values 510 and values of five different interest levels 506a-506e, which are weighted by weights 508a-e respectively. Of course, in alternative embodiments, context-based interest level predictor 502 could process different numbers and types of inputs, outputs, interest levels, weights and/or other variables.

Given the situation represented by input context values 510, the weights 508a-508e reflect the relevance of their associated interest values 506a-506e respectively to the prediction of predicted interest value 504. There are a variety of ways to determine weights 508a-508e, depending on the needs of a particular application. For example, one way of calculating weights 508a-508e is to use a distance formula. One simple example of this approach will be provided with reference to FIGS. 4B and 5.

As noted earlier, probability set 412 of FIG. 4B provides the probabilities that an interest level of 3 in news will occur in various context values, such as “home,” “work,” “morning,” “midday” and “night.” This information, together with the input context values 510 of FIG. 5, may be used to determine the relevance of an interest level of 3 to the predicted interest level 504. One simple way of doing this is to encode part of probability set 412 of FIG. 4B and the input context values 510 as vectors, and to calculate a distance between the two vectors.

For example, the set of probability values 412 could be represented as the vector [⅔ ⅓ ⅓ ⅓ ⅓]. If the input context vectors 510 of FIG. 5 represented, for instance, a user currently being at home during the midday, the corresponding input context value vector would be [1 0] combined with [0 1 0]=[1 0 0 1 0], based on the conventions described in connection with FIG. 3B. Hence a distance could be calculated between [⅔ ⅓ ⅓ ⅓ ⅓] and [1 0 0 1 0]. A similar distance calculation may also be performed for probability sets associated with other interest levels (e.g., interest level=0, interest level=1, interest level=2). This results in multiple distance values that are each associated with a specific interest level. The distance values can then be used as weights 508a-508e. The results help indicate the relevance of each interest level, and can thus influence or determine the interest level predicted for the input context values 510. The aforementioned distance may be calculated using a variety of different formulas. For example, two possibilities include a Euclidean distance formula and a cosine distance formula. Other formulas or algorithms are also possible. The cosine distance, for example, between a vector A, defined as [a₁ a₂ . . . aₙ], and a vector B, defined as [b₁ b₂ . . . bₙ], may be calculated as follows:

$$cosine D ( A , B ) = \frac{{a}_{1} {b}_{1} + {a}_{2} {b}_{2} + … + {a}_{n} {b}_{n}}{( \sqrt{{a}_{1}^{2} + {a}_{2}^{2} + … + {a}_{n}^{2}} ) ( \sqrt{{b}_{1}^{2} + {b}_{2}^{2} + … + {b}_{n}^{2}} )}$$

In some embodiments of the above equation, 0 values are converted into very small values. The above equation may be modified or reformulated, depending on the needs of a particular application.

In certain embodiments, once weights 508a-508e are calculated, they can be inputted into the context-based interest level predictor 502. The formulas used to predict an interest level may vary greatly, depending on the needs of a particular application. One approach is to use a weighted sum. The following formula, for example, makes a prediction for an interest level based on the following weighted sum equation:

$$P = \frac{{\sum }_{i = 1}^{n} {L}_{i} \times relevance ( {S}_{i} , V )}{{\sum }_{i = 1}^{n} relevance ( {S}_{i} , V )}$$

In the above exemplary equation, P is the predicted interest value for a specific interest object. L refers to the i-th interest level of n possible interest levels. The function “relevance” relates to the relevance calculations described above e.g., a distance equation. S refers to the probability set associated with the i-th interest level. V refers to the input context values.

Context-based interest level predictor 502 of FIG. 5 may produce one or more predictions. In particular embodiments it will predict interest levels for a wide range of interest objects (e.g., given that the user is at “home” in “midday,” his interest in TV is high, his interest in sports is high, his interest in spreadsheet applications is low, etc.). Particular embodiments involve interest level predictions for hundreds or thousands of interest objects.

In some cases, it may be determined that there is insufficient data to support a prediction for an interest level in a particular interest object. Some embodiments involve predicting an interest level using the interest levels predicted for one or more other interest objects (e.g., a predicted interest in pop music may be based on a predicted interest in classical music, music applications or a combination of other interest objects). Another possibility is to predict an interest level in an interest object based on evaluating and/or averaging the range of possible interest levels for that interest object. To use a simple example, if an interest in game applications is measured on a scale of 0 to 6, a 3 may be predicted for a user, since it is the midpoint of the range. Other approaches are also possible.

The prediction equation may take a number of different forms, depending on the needs of a specific application. For example, the prediction equation may involve various kinds of context values, interest levels, interest objects, weights, probability sets, variables and/or values. The weighted sum used above may be modified or replaced entirely with another equation. In certain embodiments, the prediction may be informed by factors other than the probability values, weights and interest levels referenced in the sets of probability values and/or a weighted sum formula. One embodiment may involve using predictions of various interest levels to return better search results to a user accessing a search engine. The predictions may be based not only on the context values characterizing the situation of the user (e.g., the time of day, the user's location and activity logs, etc.), but also on the keywords the user is typing in as well as other types of data. In one example, the prediction could be improved by reviewing a history of the user's past searches and/or page views and determining from them additional keywords and/or data that may help improve the accuracy of the search. In this example, such keywords and data may influence the predictions, but may not be used in a weighted sum formula and/or included in a set of probability values as described earlier.

Various embodiments of the invention can offer one or more advantages. For example, in making predictions, the invention allows for the weighing of numerous different context variables and context values, so that more accurate predictions of an entity's interests can be made. The context variables and values tracked and/or processed can vary greatly, depending on the needs of a particular application. For example, the context variables and values may pertain to geographical factors, physical/biological factors, environmental variables (e.g., location, temperature, presence of nearby devices, GPS signals, components, proximity of human beings, buildings and/or signals, motion, acceleration, velocity etc.) and/or internal variables (e.g., time, open and/or active applications, mode of operation, condition, event, power, force, Internet browsing behavior, pattern of selected ads, direct or indirect feedback from the person etc.).

Another advantage of the invention is the ability to flexibly respond to changing environments and circumstances. For example, in some embodiments new context values and variables can be easily integrated into the making of future predictions. Some embodiments do not require training or direct feedback from a user about the user's interests, because probability sets and predictions can be generated dynamically and/or invisibly from various sources of data, such as observed user behavior. Additionally, certain embodiments need not rely on predetermined rules that prioritize some context variables, context interest, interest objects and/or interest rules over others (e.g., a rule prioritizing a “place” context variable over a “time” variable, etc.). Particular embodiments involve a weighing or prioritization process that is derived entirely from a comparison between the input context values (e.g., the user is currently at “home” and it is “midday”) and the context values for the relevant probability sets (e.g., the user has shown a high level of interest in pop music 30% of the time when at home, etc.). That is, in certain embodiments, there is no need for a rule that predetermines a greater weight for one context variable, context interest, interest object and/or interest levels over others prior to the collection of data, the formation of probability sets and/or the determining of the relevance of probability sets to the input context values.

Another advantage of particular embodiments is that there is no need to cluster data. As noted earlier, certain clustering techniques, while often effective, may have several problems. Particular embodiments of the invention forego the use of clusters and do not involve defining a K number of clusters or calculating a distance between a data point and a center of a cluster of K total clusters.

An additional advantage is that particular embodiments of the invention can be used to predict the interests of a user without accessing the behavior of other users. That is, in some embodiments of the invention probability sets and predictions may be derived from data collection systems that are limited only to the contexts, behavior and/or characteristics of a single person or a selected group of people. This approach helps to improve privacy.

A number of applications may be envisioned for particular embodiments of the invention. For example, one embodiment involves a client mobile device, such as a cell phone, PDA, health monitor or portable laptop computer, and a server. The client mobile device has a communication link with the server so that data can be exchanged between them. The client mobile device may store a log of the person's behavior. Such log data could be transformed into data associations or some other format and stored in a computer readable medium. Portions or all of the log data could be processed to determine probability sets for specific interest levels in a variety of interest objects. For example, data parsing could unveil that the person often accesses spreadsheet applications in the morning at work, but checks the weather often at home at the same time, or that the person is interested in shopping around noontime on weekends. The server could determine the relevance of various interests and interest ratings for various situations, and then make one or more predictions based on an input context value (e.g., a prediction that a user, based on his past behavior, would have a very high interest in sports applications, given that the user is currently or has plans to be at home on the weekend in the evening.)

In some embodiments, an action may be taken based on a prediction once it is determined that the predicted interest level has reached a certain threshold. Embodiments of the invention involve identifying situations, as characterized by specific combinations of context values, that prompt the running of an application, because of an earlier prediction that the interest levels for one or more interest objects is particularly high when that particular combination of context values arises. In the above example, for instance, a server may calculate that a user's interest level in both shopping and social networking applications is particularly high on weekends when the device (and therefore the person) is in motion. The mobile device may transmit an alert to the server when the mobile device detects that such conditions have arisen. In response, the server may direct the mobile device to transmit ads or suggestions to the person relating directly or indirectly to shopping and social networking applications. Many variations on the above example are possible.

It should also be noted that techniques for predicting interest are also described in U.S. patent application Ser. No. (Atty Docket No. SISAP060/CSL08-NP06) entitled: “SEMANTICS-BASED INTERESTS IN COMPUTING ENVIRONMENTS AND SYSTEMS,” and U.S. patent application Ser. No. (Atty Docket No. SISAP061/CSL08-NP07) entitled: “CONTEXT-BASED INTERESTS IN COMPUTING ENVIRONMENTS AND SYSTEMS,” which are both hereby incorporated by reference herein for all purposes.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of determining an interest in an object of interest in a given situation, said method comprising:
obtaining a plurality of sets of probability values for a plurality of specific interest levels of interest in said object of interest respectively, wherein each set of probability levels includes a probability value indicative of the probability that a specific interest level of said plurality of interest levels occurring in a situation effectively represented by one or more of a plurality of context variables, each context variable having a plurality of possible context values;
obtaining input context values that effectively represent an input situation;
determining the relevance of each one of the plurality of sets of probability values to the input context values; and
determining, based on said relevancies, a projected first interest value in said object of interest, thereby determining a projected interest value for said input situation.

2. The computer-implemented method of claim 1, wherein:
at least two of each set of probability values is encoded as a first multi-dimensional vector;
at least two of the input context values are encoded as a second multi-dimensional vector; and
the determining of the projected first interest value uses a weighted sum, the weighted sum being based at least partly on the calculating of a distance between the first multi-dimensional vector and the second multi-dimensional vector.

3. The computer-implemented method of claim 1, wherein each of the plurality of context values is encoded as context vectors having at least N discrete binary values, N being an integer equal to or greater than the total number of possible context values of the plurality of context variables.

4. The computer-implemented method of claim 1, wherein each set of probability values includes a multiplicity of probabilities that a specific interest level occurs in association with different ones of the plurality of possible context values respectively.

5. The computer-implemented method of claim 1, further comprises:
obtaining data relating to a set of data associations, each data association including data association context values and a specific data association interest level, wherein a subset of the set of data associations have the same data association interest level,
wherein the obtaining of the plurality of sets of probability values includes averaging the data association context values of the subset that has the same data association interest level.

6. The computer-implemented method of claim 2, wherein the calculating of the distance includes at least one of a group consisting of: a) calculating a cosine distance; and b) calculating a Euclidean distance.

7. The computer-implemented method of claim 1, wherein the plurality of context variables includes a first context variable and a second context variable, the first context variable representing a location of the user and the second context variable representing a time of day.

8. The computer-implemented method of claim 1, wherein the determining of the relevance of each one of the plurality of sets of probability values to the input context values is not based on any predetermined rule that causes a specific context value or context variable to predominate over any other context value or context variable.

9. A computing system, wherein said computing system is operable to:
obtain a plurality of sets of probability values for a plurality of specific interest levels of interest in said object of interest respectively, wherein each set of probability levels includes a probability value indicative of the probability that a specific interest level of said plurality of interest levels occurring in a situation effectively represented by one or more of a plurality of context variables, each context variable having a plurality of possible context values;
obtain input context values that effectively represent an input situation;
determine the relevance of each one of the plurality of sets of probability values to the input context values; and
determine, based on said relevancies, a projected first interest value in said object of interest, thereby predicting a projected interest value for the input situation.

10. The computing system of claim 9 comprising:
a server adapted to perform the determining of the relevance of each one of the plurality of sets of probability values to the input context values and the determining of the projected first interest value; and
a client coupled with the server, the client adapted to perform the obtaining of the input context values and further adapted to transmit the input context values to the server.

11. The computing system of claim 10, wherein the computing system is further operable to display one or more advertisements to the user via the client, the one or more advertisements being selected based at least in part on the projected first interest value determined by the server.

12. The computing system of claim 11, wherein the client is a mobile device carried by the user, the input context values being based at least partly on GPS data generated by the mobile device.

13. The computing system of claim 9, wherein at least one of the context variables is based on one or more of the following:
a) an environmental factor and/or element;
b) an environmental factor and/or element associated with one or more humans interacting with one or more applications on the computing system;
c) environmental context of use associated with an environment of one or more humans as they interact with one or more active applications on the computing system;
d) a geographical and/or physical factor and/or element;
e) time, date, location, mode, mode of operation, condition, event, temperature, speed and/or acceleration of movement, power and/or force;
f) presence of one or more external components and/or devices;
g) presence of one or more active components operating on one or more external devices in a determined proximity of said device; and
h) one or more physiological and/or biological conditions associated with one or more persons interacting with the computing system.

14. A computer-implemented method of predicting an interest in an object of interest in a situation:
collecting user data from one or more users, the user data comprising a plurality of data associations, each data association comprising:
a first context variable and a second context variable, the first context variable having one or more of a first plurality of possible first context values and the second context variable having one or more of a second plurality of possible second context values;
a first interest level being one of a plurality of possible first interest levels and corresponding to a level of interest in a first interest object in a first situation represented by the first and second context values;
arranging the plurality of data associations into a plurality of groups, each group having one or more data associations, each of the data associations of each group having the same first interest level as other data associations in the same group, wherein each group of data associations is associated with a different first interest level;
determining a set of at least four probability values for each group, the set of probability values indicating at least in part a frequency of association between the first interest level associated with the group and the first and second pluralities of context values, thereby generating a plurality of sets of probability values and associating the plurality of sets of probability values to different ones of the plurality of possible first interest levels respectively;
obtaining at least a first input context value and a second input context value, the first and second input context values being one or more of the first and second pluralities of context values;
determining the relevance of each one of the plurality of sets of probability values and its associated first interest level to the first and second input context values;
using the relevance, a projected first interest value for a second situation of the user, the projected first interest level reflecting at least in part an interest of the user in the first interest object when the user is in a second situation represented by the first input context value and the second input context value.

15. The method of claim 14,
wherein the first context value of each one of the plurality of data associations is encoded as a vector with at least X binary values, X being an integer equal to or greater than the number of possible context values in the first plurality of possible context values; and
wherein the determining of the plurality of sets of probability values includes averaging the vectors of the data associations of each group.

16. The method of claim 14, wherein the determining of the projected first interest level uses a weighted sum, the weighted sum assigning weights to each of the plurality of possible interest levels, the assigned weights not being substantially influenced by a predetermined rule that places a greater weight on one of the plurality of possible first interest levels over another of the plurality of possible first interest levels irrespective of the collected user data.

17. The method of claim 14, wherein the determining of the projected first interest value is not based on data collected from users other than the said user.

18. The method of claim 14, wherein each of the data associations has a second interest level, the second interest level being one or more of a plurality of possible second interest levels;
ascertaining that the user data is insufficient to determine a projected second interest value in the manner of the projected first interest level;
determining, based on the the ascertaining operation, a projected second interest value for the situation of the user, the determining of the projected second interest value being based on one of the following: a) the projected first interest value; and b) averaging the plurality of possible second interest levels.

19. The method of claim 14, wherein the method does not comprise clustering the user data into K clusters, K being any predetermined integer and wherein the method does not involve approximating distances to any of the K clusters.

20. A computer readable storage medium that includes executable computer code embodied in a tangible form operable to determine an interest in an object of interest in a situation, wherein the computer readable medium includes:
executable computer code operable to obtain a plurality of sets of probability values for a plurality of specific interest levels of interest in said object of interest respectively, wherein each set of probability levels includes a probability value indicative of the probability that a specific interest level of said plurality of interest levels occurring in a situation effectively represented by one or more of a plurality of context variables, each context variable having a plurality of possible context values;
executable computer code operable to obtain input context values that effectively represent an input situation;
executable computer code operable to determine the relevance of each one of the plurality of sets of probability values to the input context values; and
executable computer code operable to determine, based on said relevancies, a projected first interest value in said object of interest, thereby predicting a projected interest value for the input situation.
